(19) United States
(12) Patent Application Publication
(10) Pub. No.: US 2015/0237525 A1
(43) Pub. Date: Aug. 20, 2015

(54) Traffic Shaping and Steering for a Multipath Transmission Control Protocol Connection

(71) Applicant: TELEFONAKTIEBOLAGET L M ERICSSON (PUBL), Stockholm (SE)

(72) Inventors: Gunnar Mildh, Sollentuna (SE); Jari Vikberg, Jarna (SE)

(21) Appl. No.: 14/430,277

(22) PCT Filed: Sep. 24, 2012
(86) PCT No.: PCT/EP2012/068790

§ 371 Date: Mar. 23, 2015

(51) Int. Cl. H04W 28/02; H04L 12/707; H04L 12/825; H04L 12/815

(52) U.S. Cl. CPC H04W 28/0215; H04L 47/22; H04L 45/24; H04W 28/0236; H04L 47/26

(57) ABSTRACT

There is provided a method of enabling traffic steering and shaping for subflows of a Multipath Transmission Control Protocol (MPTCP) connection, wherein the subflows of the connection are carried over a plurality of Radio Access Networks (RANs). The method involves determining that the device is communicating with an end host using MPTCP, obtaining network information relating to the device, and using the device-related network information to decide whether any traffic steering and shaping should be applied to any subflow of the MPTCP connection. Appropriate actions can then be executed in relation to one or more of the subflows of the MPTCP connection in order to implement the traffic steering and shaping decision.

### TECHNICAL FIELD

The present invention relates to traffic shaping and steering for a Multipath Transmission Control Protocol (MPTCP) connection.

### BACKGROUND

The Transmission Control Protocol (TCP) is a transport layer protocol used by applications that require guaranteed delivery. TCP establishes a full duplex logical connection between two endpoints/end hosts, wherein each end host is defined by an IP address and a TCP port number.

Whilst TCP communication is restricted to a single path per connection, multiple paths often exist between end hosts. For example, as data traffic in mobile telecommunications networks is continually increasing, operators are employing heterogeneous access networks that utilise multiple radio access technologies (RATs) in order to provide greater capacity. Typically, the radio access technologies utilised as part of these heterogeneous access networks include UMTS Radio Access Network (UTRAN) and an Evolved UTRAN (E-UTRAN), and Wi-Fi/WLAN. It is therefore possible that contemporary devices (e.g. user equipment, stations etc) could simultaneously connect to the Internet via more than one Radio Access Networks (RAN). Resource usage would therefore be more efficient if these multiple paths were used concurrently, and would enhance the user experience through improved resilience to network failure and higher throughput.

Multipath TCP (MPTCP) provides a set of extensions to TCP that enable a transport connection to simultaneously use multiple paths (i.e. each defined by a different source and destination address pair) between end hosts, where one or both of the end hosts are multi-homed. In this context, an MPTCP connection is a set of one or more subflows over which an application can communicate between two end hosts, wherein a subflow is a flow of TCP segments operating over an individual path (i.e. a single-path TCP connection). A subflow is started and terminated similarly to a regular TCP connection and, to the network layer, each subflow of an MPTCP connection therefore looks like a regular TCP flow whose segments carry a new TCP option type. MPTCP operates at the transport layer and aims to be transparent to both higher and lower layers. It is a set of additional features on top of standard TCP, and FIG. 1 illustrates a comparison of the standard TCP protocol stack and the MPTCP protocol stack.

FIGS. 2 and 3 illustrate schematically examples of the two main deployment scenarios for MPTCP. FIG. 2 illustrates a device in communication with an Internet server over both a 3GPP RAN and a Wi-Fi RAN/WLAN, wherein both the device and the server support MPTCP. The device and the server are therefore the end hosts of the MPTCP connection, wherein a first subflow of the MPTCP connection is carried over the 3GPP RAN and a second subflow of the MPTCP connection is carried over the Wi-Fi RAN/WLAN. FIG. 3 illustrates a device in communication with an Internet server over both a 3GPP RAN and a Wi-Fi RAN/WLAN; however, whilst the device does support MPTCP, the server does not. An MPTCP proxy can therefore be introduced in any intermediate node between the device and the server (for example in the RAN, in the core network, in the service network, or in the Internet) so that the MPTCP can still be used over the RANs. The MPTCP proxy then communicates with the server using standard TCP.

At a high level, when MPTCP is used for data transfer, an MPTCP implementation will take one input data stream from an application, and split it into one or more subflows, with sufficient control information to allow it to be reassembled and delivered reliably and in-order to the recipient application. This control information is provided by a “Data Sequence Signal” optional TCP header field that is included in at least some of the TCP packets/segments of the subflow. FIG. 4 illustrates the format of the Data Sequence Signal option. The Data Sequence Signal option carries a “Data Sequence Mapping” that consists of a subflow sequence number that is mapped to a data-level sequence number (i.e. the Data Sequence Number (DSN)), and a number of bytes (i.e. the length) for which this mapping is valid This option can also carry a connection-level acknowledgement (the “Data ACK”) for the received DSN.

A problem that can arise from the use of MPTCP, and that has not previously been considered, is that TCP will always try to make full use of the bit pipe that is available in the network. For example, in the case of an MPTCP connection in which one TCP subflow is carried over a 3GPP RAN and a further TCP subflow is carried over a Wi-Fi RAN, both subflows will attempt to maximise their throughput over their respective access networks. However, it is not always optimal to maximize the usage of the different accesses. Continuing with the preceding example, if a device is in a location in which the coverage provided by one of these two access networks is poor, then it would be optimal to minimize the usage of that access until the coverage improves. In doing so, the device would save battery power by avoiding transmissions in the access with poor coverage, which would otherwise require higher transmission power. In addition, by maximising the throughput over their respective access networks, the network resource consumption of an MPTCP connection could be unfair on other network users. For example, for a user whose device is making use of an MPTCP connection in which one TCP subflow is carried over a 3GPP RAN and a further TCP subflow is carried over a Wi-Fi RAN, these subflows would use both connections to the maximum extent possible, which could be detrimental to other those users who only have 3GPP access.

### SUMMARY

In order to at least mitigate the problems identified above there will now be described methods and apparatus for enabling traffic steering and shaping for the multiple subflows of a Multipath Transmission Control Protocol (MPTCP) connection of a device that is connected to a core network via a plurality of RANs.

According to a first aspect there is provided a method of enabling traffic steering and shaping for subflows of a MPTCP connection of a device wherein the subflows of the MPTCP connection are carried over a plurality of RANs. The method comprises, at a traffic steering and shaping decision function:
determining that the device is communicating with an end host using MPTCP;
obtaining information that is relevant to the device for one or more of any of the plurality of RANs that carry a subflow of the MPTCP connection, a core network, and a service network; and
using the device-relevant information to decide whether any traffic steering and shaping should be applied to any of the subflows of the MPTCP connection.

The step of determining that the device is communicating with an end host using MPTCP may comprise receiving a notification from an MPTCP detection function, the notification indicating that at an MPTCP connection is being used by the device.

The step of obtaining information that is relevant to the device may comprise one or more of retrieving device-relevant information from the notification received from the MPTCP detection function, retrieving device-relevant information that has previously been stored by the traffic steering and shaping decision function, and sending a request for device-relevant information to, and receiving a response from, at least one device context acquisition function.

The method may further comprise sending a control message to a traffic steering and shaping execution function, the control message instructing the traffic steering and shaping execution function to implement the traffic steering and shaping decision by executing any appropriate actions in relation to one or more of the subflows of the MPTCP connection.

The traffic steering and shaping decision function may implemented at any node within a path over which any subflow of the MPTCP connection operates. The traffic steering and shaping decision function may therefore be implemented at any of the device, the end host, a node of any of the plurality of RANs that carry a subflow of the MPTCP connection, a node of the core network, and a node of the service network. In this regard, the end host may be any of an MPTCP Server and an MPTCP Proxy.

According to a second aspect there is provided a method of enabling traffic steering and shaping for subflows of a MPTCP connection of a device, wherein the subflows of the MPTCP connection are carried over a plurality of RANs. The method comprises, at a MPTCP detection function:
detecting that the device is communicating with an end host using MPTCP; and
sending a notification to a traffic steering and shaping decision function, the notification indicating that an MPTCP connection is being used by the device, thereby allowing the traffic steering and shaping decision function to decide whether any traffic steering and shaping should be applied to any of the subflows of the MPTCP connection.

The step of detecting that the device is communicating with an end host using MPTCP may comprises, during setup of a subflow of the MTCP connection between the device and the end host, determining that both the device and the end host are MPTCP capable and that the device has indicated that MPTCP should be used. Alternatively, the step of detecting that the device is communicating with an end host using MPTCP may comprise performing packet inspection of packets sent over a subflow of the MTCP connection between the device and the end host.

The method may further comprise using data sequence information in the subflow to determine traffic division between the subflow and a further subflow of the MPTCP connection, and including traffic division information in the notification sent to the traffic steering and shaping decision function.

The MPTCP detection function may be implemented at any node within a path over which any of the subflows of the MPTCP connection operates. The MPTCP detection function may therefore be implemented at any of the device, the end host, a node of any of the plurality of RANs that carry a subflow of the MPTCP connection, a node of a core network, and a node of a service network. In this regard, the end host may be any of a MPTCP Server, and a MPTCP Proxy.

According to a third aspect there is provided a method of enabling traffic steering and shaping for subflows of a MPTCP connection of a device, wherein the subflows of the MPTCP connection are carried over a plurality of RANs. The method comprises, at a device context acquisition function:
receiving a request for device-relevant information, the request including an identifier of the device;
using the identifier of the device to obtain information that is relevant to the device from one or more of any of the plurality of RANs that carry a subflow of the MPTCP connection, a core network, and a service network; and
sending a response including the obtained device related information.

The request may be received from, and the response sent to, a traffic steering and shaping decision function.

The device context acquisition function may be implemented at any of a node of any of the plurality of RANs that carry a subflow of the MPTCP connection, a node of the core network, and a node of the service network.

According to a fourth aspect there is provided a method of enabling traffic steering and shaping for subflows of a MPTCP connection of a device, wherein the subflows of the MPTCP connection are carried over a plurality of RANs. The method comprises, at a traffic steering and shaping execution function:
receiving a control message instructing the traffic steering and shaping execution function to implement a traffic steering and shaping decision;
determining actions that can be performed in order to implement the decision; and
implementing the traffic steering and shaping decision by executing the determined actions in relation to one or more of the subflows of the MPTCP connection.

The control message may be received from a traffic steering and shaping decision function.

The actions for implementing the traffic steering and shaping decision may comprise any of:
dropping, re-directing or delaying any of packets, re-transmissions, or acknowledgements that are sent over one or more subflows of the MPTCP connection; and
implementing Explicit Congestion Notification, ECN, for one or more subflows of the MPTCP connection.

The traffic steering and shaping execution function may be implemented at a node within a path over which any of the subflows of the MPTCP connection operates. The traffic steering and shaping execution function may therefore implemented at any of the device, an end host with which the device is communicating, a node of any of the plurality of RANs that carry a subflow of the MPTCP connection, a node of a core network, and a node of a service network. In this regard, the end host may be any of a MPTCP Server, and a MPTCP Proxy.

According to a fifth aspect there is provided an apparatus configured to operate as a traffic steering and shaping decision function for enabling traffic steering and shaping for subflows of a MPTCP connection of a device, wherein the subflows of the MPTCP connection are carried over a plurality of RANs. The apparatus comprises:
a determination unit configured to determine that the device is communicating with an end host using MPTCP;
an information acquisition unit configured to obtain information that is relevant to the device for one or more of any of the plurality of RANs that carry a subflow of the MPTCP connection, a core network, and a service network; and
a decision unit configure to use the device-relevant information to decide whether any traffic steering and shaping should be applied to any of the subflows of the MPTCP connection.

The determination unit may be further configured to receive a notification from an MPTCP detection function, the notification indicating that at an MPTCP connection is being used by the device.

The information acquisition unit may be further configured to obtain information that is relevant to the device by implementing one or more of:
retrieving device-relevant information from the notification received from the MPTCP detection function;
retrieving device-relevant information that has previously been stored by the traffic steering and shaping decision function; and
sending a request for device-relevant information to, and receiving a response from, at least one device context acquisition function.

The apparatus may further comprise a control unit configured to generate and send a control message to a traffic steering and shaping execution function, the control message instructing the traffic steering and shaping execution function to implement the traffic steering and shaping decision by executing any appropriate actions in relation to one or more of the subflows of the MPTCP connection.

The apparatus may be a node within a path over which any subflow of the MPTCP connection operates. Therefore the apparatus may be any of the device, the end host, a node of any of the plurality of RANs that carry a subflow of the MPTCP connection, a node of the core network, and a node of the service network. In this regard, the end host may be any of a MPTCP Server, and a MPTCP Proxy.

According to a sixth aspect there is provided an apparatus configured to operate as a MPTCP detection function for enabling traffic steering and shaping for subflows of a MPTCP connection of a device, wherein the subflows of the MPTCP connection are carried over a plurality of RANs. The apparatus comprises:
a detection unit configured to detect that the device is communicating with an end host using MPTCP; and
a notification unit configured to generate and send a notification to a traffic steering and shaping decision function, the notification indicating that a MPTCP connection has been established for the device, thereby allowing the traffic steering and shaping decision function to decide whether any traffic steering and shaping should be applied to any of the subflows of the MPTCP connection.

The detection unit may be further configured to, during setup of a subflow of the MTCP connection between the device and the end host, determine that both the device and the end host are MPTCP capable and that the device has indicated that MPTCP should be used. Alternatively, the detection unit may be further configured to perform packet inspection of packets sent over one or more subflows of the MTCP connection between the device and the end host.

The apparatus may comprise a traffic division determination unit configured to use data sequence information carried in the subflows of the MTCP connection to determine traffic division between the subflows, and to include traffic division information in the notification sent to the traffic steering and shaping decision function.

The MPTCP detection function may be implemented at a node within a path over which any of the subflows of the MPTCP connection operates. Therefore, the apparatus may be any of the device, the end host, a node of any of the plurality of RANs that carry a subflow of the MPTCP connection, a node of a core network, and a node of a service network. In this regard, the end host may be any of a MPTCP Server, and a MPTCP Proxy.

According to a seventh aspect there is provided an apparatus configured to operate as a device context acquisition function for enabling traffic steering and shaping for subflows of a MPTCP connection of a device, wherein the subflows of the MPTCP connection are carried over a plurality of RANs. The apparatus comprises:
a request unit configured to receive a request for device-relevant information, the request including an identifier of the device;
an information acquisition unit configured to use the identifier of the device to obtain information that is relevant to the device from one or more of any of the plurality of RANs that carry a subflow of the MPTCP connection, a core network, and a service network; and
a response unit configured to generate and send a response including the obtained device related information.

The apparatus may any of a node of any of the plurality of RANs that carry a subflow of the MPTCP connection, a node of the core network, and a node of the service network.

According to an eighth apparatus configured to operate as a traffic steering and shaping execution function for enabling traffic steering and shaping for subflows of a MPTCP connection of a device, wherein the subflows of the MPTCP connection are carried over a plurality of RANs. The apparatus comprises:
a decision processing unit configured to receive a control message instructing the traffic steering and shaping execution function to implement a traffic steering and shaping decision, and to determine actions that can be performed in order to implement the decision; and
an execution unit configured to implement the traffic steering and shaping decision by executing the determined actions in relation to one or more of the subflows of the MPTCP connection.

The execution unit may be configured to execute actions that comprise any of:
dropping, re-directing or delaying any of packets, re-transmissions, or acknowledgements that are sent over one or more subflows of the MPTCP connection; and
implementing Explicit Congestion Notification, ECN, for one or more subflows of the MPTCP connection.

The apparatus may be any node within a path over which any of the subflows of the MPTCP connection operates. Therefore the apparatus may be any of the device, an end host with which the device is communicating, a node of any of the plurality of RANs that carry a subflow of the MPTCP connection, a node of a core network, and a node of a service network. In this regard, the end host may be any of a MPTCP Server, and a MPTCP Proxy.

### BRIEF DESCRIPTION OF THE DRAWINGS

Aspects of the present invention will now be further described, by way of example only, with reference to the accompanying figures.

FIG. 1 illustrates a comparison of the standard TCP protocol stack and the MPTCP protocol stack;

FIG. 2 illustrates a device in communication with an Internet server over both a 3GPP RAN and a WLAN, wherein both the device and the server support MPTCP;

FIG. 3 illustrates a device in communication with an Internet server over both a 3GPP RAN and a WLAN via an MPTCP proxy;

FIG. 4 illustrates the format of the Data Sequence Signal option of MPTCP;

FIG. 5 illustrates schematically functional entities for implementing the methods described herein;

FIG. 6 illustrates schematically an embodiment of a MPTCP detection function configured to implement the methods described herein;

FIG. 7 illustrates schematically an embodiment of a decision function configured to implement the methods described herein;

FIG. 8 illustrates schematically an embodiment of an execution function configured to implement the methods described herein;

FIG. 9 illustrates schematically an embodiment of a device context acquisition function configured to implement the methods described herein;

FIG. 10 is a signalling flow diagram illustrating an example of an implementation of the method described herein;

FIG. 11 is a signalling flow diagram illustrating an example of an implementation of the method described herein;

FIG. 12 is a signalling flow diagram illustrating an example of an implementation of the method described herein; and

FIG. 13 is a signalling flow diagram illustrating an example of an implementation of the method described herein.

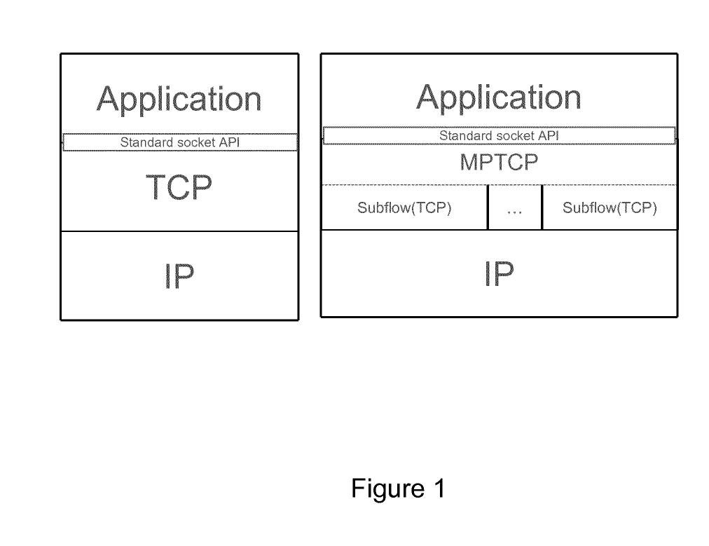

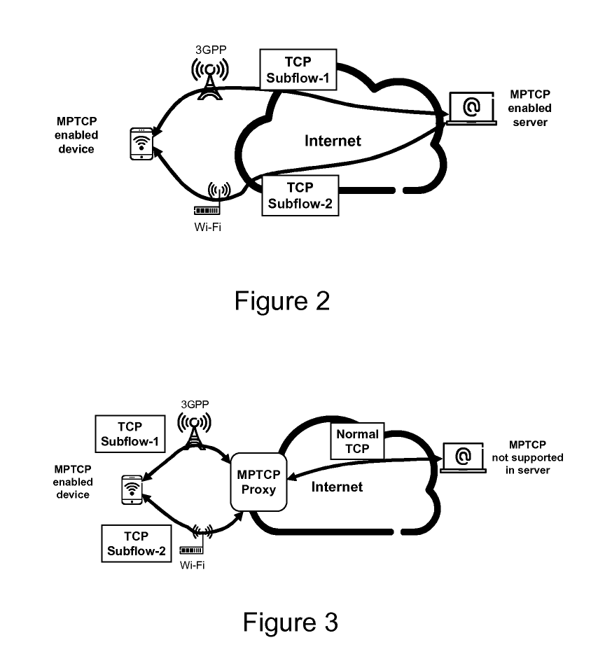

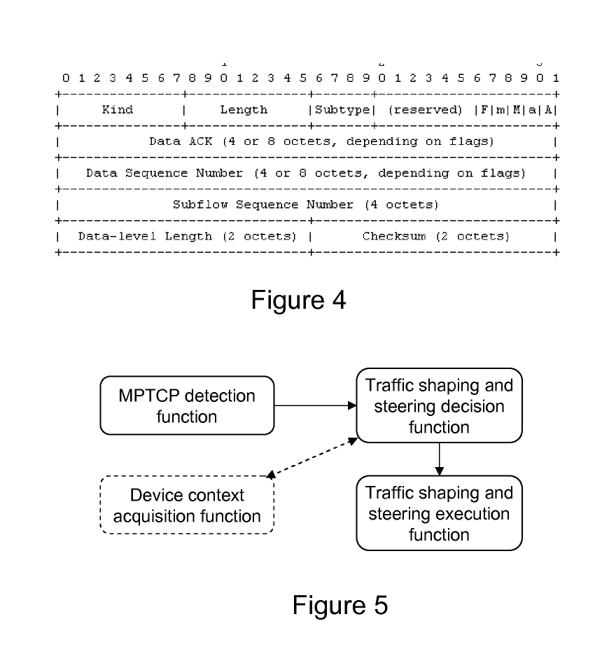

### DETAILED DESCRIPTION

There will now be described a method of enabling traffic steering and shaping for subflows of a Multipath Transmission Control Protocol (MPTCP) connection, wherein the subflows of the connection are carried over a plurality of RANs. In this context, traffic steering and shaping involves controlling the distribution of data traffic between the subflows of an MPTCP connection. The method involves determining that the device is communicating with an end host using MPTCP, obtaining network information relating to the device, and using the device-related network information to decide whether any traffic steering and shaping should be applied to any subflow of the MPTCP connection. Appropriate actions can then be executed in relation to one or more of the subflows of the MPTCP connection in order to implement the traffic steering and shaping decision.

The device-related network information can relate to one or more of any of the plurality of RANs that carry a subflow of the MPTCP connection, a core network, and a service network. For example, the device-related network information can include but it is not limited to RAN load (e.g. on a cell or node level), the current bitrate available to the device, device mobility, subscription information, and the current radio conditions of the device etc. By way of example, the core network can include both control plane nodes and user plane nodes, and nodes that are part of both the control plane and the user plane, such as a Mobility Management Entity (MME), a Serving GPRS Support Node (SGSN), a Serving Gateway (S-GW), and a Packet Data Network (PDN-GW). The service network can include, for example, nodes and functions holding subscription or policy information, such as a Home Subscriber Server (HSS), Home Location Register/Authentication Center (HLR/AuC), and a Policy and Charging Rules Function (PCRF). By way of further example, the service network nodes can also include nodes that are located above the core network and that can for example apply different packet inspection mechanisms to detect what services the device is using.

This method can be implemented in a variety of different ways by making use of a number of different functional entities wherein one or more of these functional entities can be provided by any one of a number of different nodes. These functional entities include at least a MPTCP detection function, a traffic steering and shaping decision function, and a traffic steering and shaping execution function.

At the least, the MPTCP detection function is configured to detect that when a device is communicating with an end host using MPTCP, and to inform the traffic steering and shaping decision function. The traffic steering and shaping decision function is then configured to retrieve device-related network information and to use the device-related network information to decide whether any traffic steering and shaping should be applied to any subflow of the MPTCP connection. If the traffic steering and shaping decision function decides that traffic steering and shaping should be applied to one or more of the subflows of the MPTCP connection, the traffic steering and shaping decision function instructs the traffic steering and shaping execution function to implement the decision. The traffic steering and shaping execution function is then configured to implement the traffic steering and shaping decision by performing appropriate actions in relation to one or more of the subflows of the MPTCP connection.

In addition, if the traffic steering and shaping decision function does not already have device-related network information, or it is not straightforward for the traffic steering and shaping decision function to obtain device-related network information for itself, then the traffic steering and shaping decision function can retrieve the device-related network information by communicating with one or more device context acquisition functions, wherein a device context acquisition function obtains the device-related network information and provides this to the traffic steering and shaping decision function.

FIG. 5 illustrates schematically each of these functional entities and there relative interactions, wherein the device context acquisition function is optional (as indicated by the dashed lines). As noted above, each of these functional entities can be distributed/grouped in a number of different ways and at a number of different nodes, wherein these nodes can include the device, the end host with which the device is communicating, a node in a core network, a node within the RANs that carry any of the subflows of the MPTCP connection, and a node in a service network.

In order to detect that a device is communicating with an end host using MPTCP, the MPTCP detection function can be configured to perform packet inspection of packets (i.e. TCP segments) sent over a subflow of the MPTCP connection between the device and the end host. For example, this would be the case if the MPTCP detection function was to be implemented at an intermediate node (i.e. a node other than the device or end host) that is located within a path over which a subflow of the MPTCP connection operates. The packet inspection would then attempt to determine if the packets/TCP segments include the optional headers that are used to establish a subflow between the device and the end host (i.e. either the Multipath Capable (MP_CAPABLE) or the Join Connection (MP_JOIN)) TCP option).

Alternatively, the MPTCP detection function can be configured to determine, during setup of a subflow of the MPTCP connection between the device and the end host, that both the device and the end host are MPTCP capable and that the device has indicated that MPTCP should be used. For example, this would be the case if the MPTCP detection function was to be implemented at either the device or the end host (i.e. a MPTCP Server or MPTCP Proxy), such that the MPTCP detection function would be able to determine this information directly from the optional headers (i.e. either the Multipath Capable (MP_CAPABLE) or the Join Connection (MP_JOIN)) TCP option) of the TCP packets that are used to establish a subflow between the device and the end host.

When the MPTCP detection function detects that a device is communicating with an end host using MPTCP, the MPTCP detection function is configured to send a notification to the traffic steering and shaping decision function, the notification indicating that an MPTCP connection is being used by the device. The MPTCP detection function can also be further configured to obtain at least one identifier for the device, and to include at least one identifier for the device in the notification sent to the traffic steering and shaping decision function. For example, if the MPTCP detection function was to be implemented within a node of a RAN that carries a subflow of the MPTCP connection, then the MPTCP detection function could be configured to obtain an identifier for the device that is associated with/used by that RAN. Expanding upon this example, if the MPTCP detection function was to be implemented within an eNodeB of an E-UTRAN, then the eNodeB would be provided with a temporary identity such as the Globally Unique Temporary UE Identity (GUTI) or a SAE Temporary Mobile Subscriber Identity (S-TMSI) that identifies the device within the E-UTRAN, and could include this temporary device identity in the notification. As an alternative, if the MPTCP detection function is configured to send the notification to the traffic steering and shaping decision function over a signalling connection that has been established for the device, then the device identity would be inferred/implicit to the traffic steering and shaping decision function from the specific signalling connection over which the notification is received. For example, if the MPTCP detection function was implemented within an eNodeB and the traffic steering and shaping decision function was implemented within a MME (or a S-GW), then the eNodeB would send the indication using a device specific signalling connection (or user plane connection), and the traffic steering and shaping decision function would know the identity of the device based on the connection over which the notification is received.

In addition, the MPTCP detection function can also be configured to use data sequence information included within the packets/TCP segments of a subflow of the MPTCP connection to determine the traffic division between all of the subflows of the MPTCP connection. The MPTCP detection function would then be further configured to include traffic division information in the notification sent to the traffic steering and shaping decision function. The traffic steering and shaping decision function could then use this traffic division information together with the device-related network information when deciding whether any traffic steering and shaping should be applied to any of the subflows of the MPTCP connection.

Furthermore, if the MPTCP detection function was to be implemented with a node of a RAN that carries a subflow of the MPTCP connection, then the MPTCP detection function could be further configured such that, upon detecting that a device is communicating with an end host using MPTCP, it would obtain device-related network information from within that RAN and include this in the notification sent to the traffic steering and shaping decision function. In this case, the MPTCP detection function could be considered as being collocated with a device context acquisition function.

Based on the notification received from the MPTCP detection function, the traffic steering and shaping decision function determines that the device is communicating with an end host using the MPTCP. The traffic steering and shaping decision function then needs to retrieve network information relating to the device for use in deciding whether any traffic steering and shaping actions should be applied to any subflow of the MPTCP connection. This device-related network information can relate to one or more of any of the RANs that carry a subflow of the MPTCP connection, a core network, and a service network. By way of example, this device-related network information could include any of RAN load (e.g. on the cell or node level), the current bit-rate for the device, device information available in the core network such as device type, subscription information, or information about service(s) currently being used by the device.

In order to retrieve the device-related network information, the traffic steering and shaping decision function can retrieve network information from the notification received from the MPTCP detection function. For example, as noted above, the MPTCP detection function may include device-related network information in the notification sent to the traffic steering and shaping decision function, although this may depend upon which node implements the MPTCP detection function. Alternatively, the traffic steering and shaping decision function can retrieve network information that it has previously stored. For example, depending upon which node is implementing the traffic steering and shaping decision function, the traffic steering and shaping decision function may have access to network information or be provided with network information by other nodes, as part of the standard functionality of that node. In particular, if the traffic steering and shaping decision function is implemented within a node of the RAN or a node of the core network, then this node may already have access to at least some network information that is relevant to the device. Alternatively, the traffic steering and shaping decision function can be configured to send a request for device-related network information to, and to receive a response from, at least one device context acquisition function. For example, the traffic steering and shaping decision function could send a request to a single device context acquisition function that is capable of obtaining device-related network information from several of the networks (i.e. the RANs carrying the subflows of the MPTCP connection, the core network, and the service network). As an alternative example, the traffic steering and shaping decision function could send requests to more than one device context acquisition function, wherein each of these device context acquisition functions is capable of obtaining device-related network information from a different network. As a further example, the traffic steering and shaping decision function could send a request to a single device context acquisition function that is only capable of obtaining device-related network information from one of the networks.

The traffic steering and shaping decision function is then configured to use the device-related network information to decide whether any traffic steering and shaping actions should be implemented for any of the subflows of the MPTCP connection. By way of example, the decision can be based on pre-configured policies that are then applied to the device-related network information. The traffic steering and shaping decision function can then be configured to send a control message to a traffic steering and shaping execution function, the control message including the traffic steering and shaping decision.

As described above, each of the functional entities can be distributed/grouped in a number of different ways at a number of different nodes. In this regard, the traffic steering and shaping decision function can be implemented at any node located within a path over which a subflow of the MPTCP connection operates. Such nodes include the device, the end host with which the device is communicating (i.e. a MPTCP Server/Proxy), and any of the intermediate nodes. For example, the intermediate nodes can include the nodes of a RAN that carries a subflow of the MPTCP connection, the nodes of a core network and the nodes of a service network. As such, the traffic steering and shaping decision function could be implemented at the same node as one or more of any of the other functions described herein, or could be implemented at a different node to all of the other functions described herein.

If required, a device context acquisition function is configured to receive a request for device related network information from the traffic steering and shaping decision function, the request including at least an identifier of the device. The device context acquisition function is then configured to use the identifier of the device to obtain device-related network information for one or more of any of the plurality of RANs that carry a subflow of the MPTCP connection, a core network, and a service network. The device context acquisition function is then configured to send a response including the obtained device-related network information to the traffic steering and shaping decision function. The steps implemented by a device context acquisition function to obtain device-related network information is beyond the scope of the methods described herein; however, PCT/SE2012/051007 describes exemplary methods and apparatus that would be suitable for providing the functionality of a device context acquisition function.

As described above, each of the functional entities can be distributed/grouped in a number of different ways at a number of different nodes. In this regard, the device context acquisition function can be implemented at any of the intermediate nodes. For example, the intermediate nodes can include the nodes of a RAN that carries a subflow of the MPTCP connection, the nodes of the core network and the nodes of a service network. As such, the device context acquisition function could be implemented at the same node as one or more of any of the other functions described herein, or could be implemented at a different node to all of the other functions described herein.

The traffic steering and shaping execution function is configured to implement the traffic steering and shaping decision made by the traffic steering and shaping decision function. To do so, the traffic steering and shaping execution function is configured to receive a control message from the traffic steering and shaping decision function that includes the traffic steering and shaping decision. The traffic steering and shaping execution function is then configured to implement the traffic steering and shaping decision by performing appropriate actions in relation to one or more of the subflows of the MPTCP connection. In this regard, the traffic steering and shaping execution function will process the traffic steering and shaping decision to determine which actions it can perform that will implement the decision. For example, these traffic steering and shaping actions can include any of dropping, re-directing or delaying any of packets, re-transmissions, or acknowledgements sent over a subflow of the MPTCP connection. In addition, the traffic steering and shaping actions can also include implementing Explicit Congestion Notification (ECN) for a subflow of the MPTCP connection. In this regard, ECN is an extension to TCP that allows end-to-end notification of network congestion, without dropping packets, so that a sender can reduce its transmission rate. ECN is normally used to inform the receiver that congestion has taken place and then the receiver informs the sender via other mechanisms than ECN.

By way of example, the decision received from the traffic steering and shaping decision function can indicate “throttle MPTCP subflow X for subscriber Y totally”, and an appropriate action that could then be executed by the traffic steering and shaping execution function in order to implement this decision could be to drop all or parts of the packets related to that flow. The traffic steering and shaping decision function could also introduce delays or lower the bit rate of a specific MPTCP subflow, thus triggering TCP rate adaptation and congestion management mechanisms which will slow down the offered traffic in the sender for this particular subflow. This can be seen as an implicit steering of traffic between subflows.

As a further example, if the traffic steering and shaping execution function was implemented in the device or the end host with which the device is communicating, then steering of traffic between the subflows of an MPTCP connection can be directly controlled by dividing/mapping the traffic between the subflows. For example, to throttle one of the subflows, the MPTCP layer implemented at the device or the end host could simply allocate fewer packets to that subflow.

As described above, each of the functional entities can be distributed/grouped in a number of different ways at a number of different nodes. In this regard, the traffic steering and shaping execution function can be implemented at any user plane node located within a path over which a subflow of the MPTCP connection operates. As such, the traffic steering and shaping execution function could be implemented at the same node as one or more of any of the other functions described herein, or could be implemented at a different node to all of the other functions described herein.

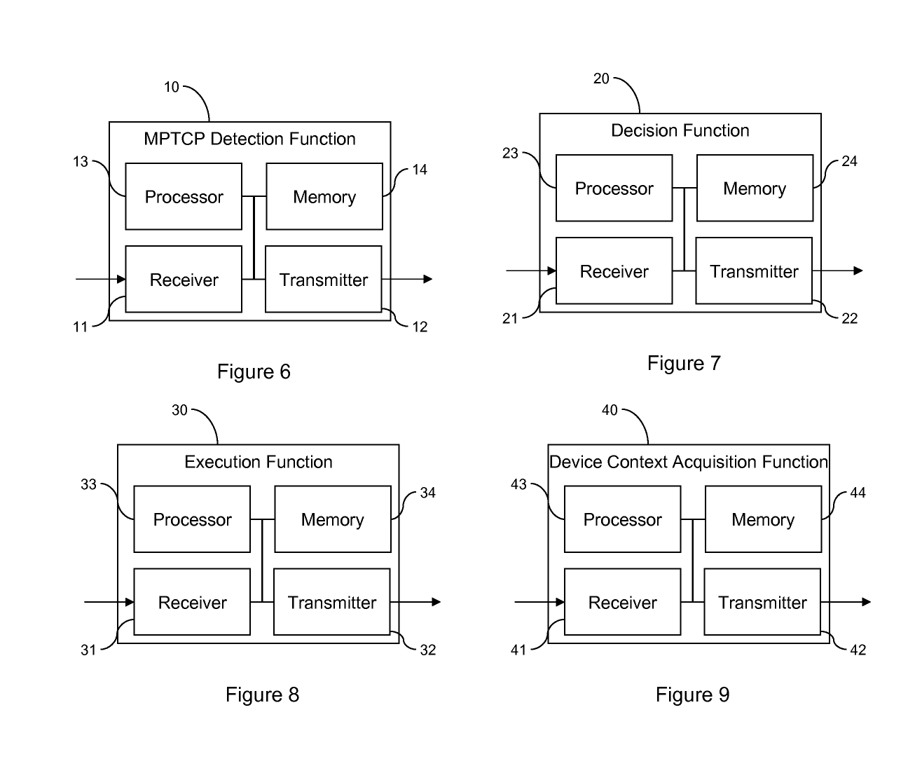

FIG. 6 illustrates schematically an embodiment of a MPTCP detection function 10 configured to implement the methods described above. The MPTCP detection function 10 can be implemented as a combination of computer hardware and software and comprises a receiver 11, transmitter 12, a processor 13, and a memory 14. The memory 14 stores the various programs/executable files that are implemented by the processor 13, and also provides a storage unit for any required data. The programs/executable files stored in the memory 14, and implemented by the processor, can include but are not limited to a detection unit, a notification unit, and a traffic division determination unit that are configured to implement the methods described above.

FIG. 7 illustrates schematically an embodiment of a traffic shaping and steering decision function 20 configured to implement the methods described above. The traffic shaping and steering decision function 20 can be implemented as a combination of computer hardware and software and comprises a receiver 21, transmitter 22, a processor 23, and a memory 24. The memory 24 stores the various programs/executable files that are implemented by the processor 23, and also provides a storage unit for any required data. For example, the memory 24 can store any received network information and any decision making policies. The programs/executable files stored in the memory 24, and implemented by the processor, can include but are not limited to a determination unit, an information acquisition unit, a decision unit, and a control unit configured to implement the methods described above.

FIG. 8 illustrates schematically an embodiment of a traffic shaping and steering execution function 30 configured to implement the methods described above. The traffic shaping and steering execution function 30 can be implemented as a combination of computer hardware and software and comprises a receiver 31, transmitter 32, a processor 33, and a memory 34. The memory 34 stores the various programs/executable files that are implemented by the processor 33, and also provides a storage unit for any required data. The programs/executable files stored in the memory 34, and implemented by the processor, can include but are not limited to a decision processing unit, and an execution unit configured to implement the methods described above.

FIG. 9 illustrates schematically an embodiment of a device context acquisition function 40 configured to implement the methods described above. The device context acquisition function 40 can be implemented as a combination of computer hardware and software and comprises a receiver 41, transmitter 42, a processor 43, and a memory 44. The memory 44 stores the various programs/executable files that are implemented by the processor 43, and also provides a storage unit for any required data. The programs/executable files stored in the memory 44, and implemented by the processor, can include but are not limited to a request unit, an information acquisition unit, and a response unit configured to implement the methods described above.

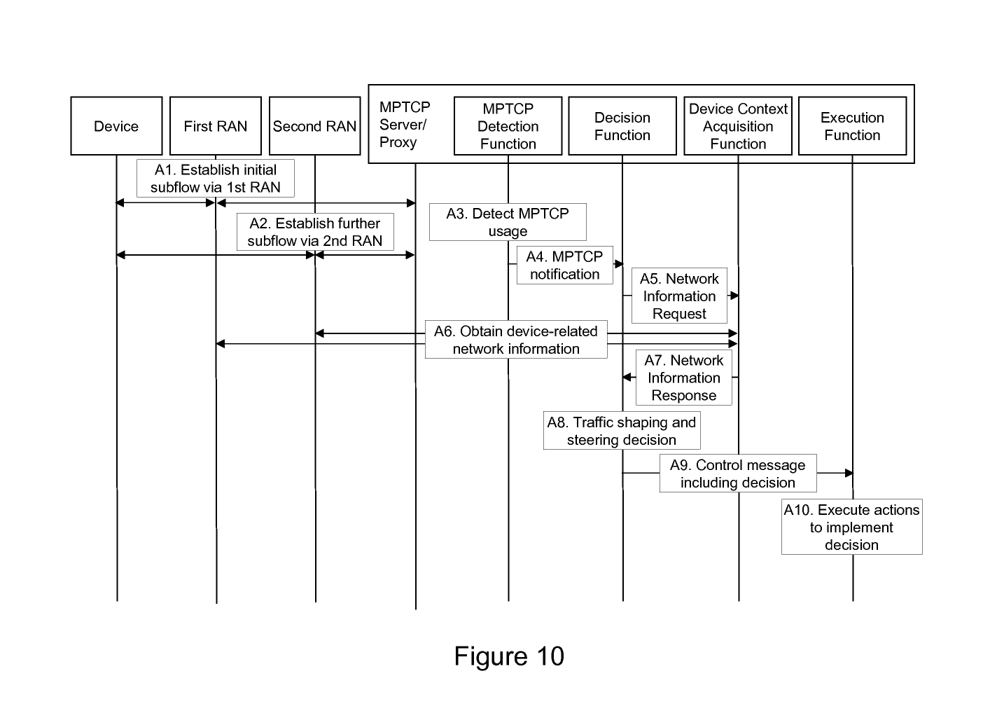

FIG. 10 is a signalling flow diagram illustrating an example of an implementation of the method described herein. In this example, the device is communicating with a MPTCP Server/Proxy that implements all of the functions that are required to enable the traffic steering and shaping of the subflows of the MPTCP connection. The steps performed are as follows:

A1. The device establishes an initial TCP connection with the MPTCP Server/Proxy through a first RAN. During establishment of the connection, both the device and the MPTCP Server/Proxy include optional headers that indicate that they support MPTCP.
A2. The device then establishes a further TCP connection with the MPTCP Server/Proxy through a second RAN, and includes an optional header indicating that this further TCP connection is to be joined with the initial TCP connection as a MPTCP connection. The initial TCP connection and the further TCP connection are therefore subflows of the MPTCP connection.
A3. The MPTCP detection function implemented at the MPTCP Server/Proxy thereby detects that MPTCP is being used for the communication between the device and the MPTCP Server/Proxy.
A4. The MPTCP detection function therefore notifies a traffic steering and shaping decision function that is also implemented at the MPTCP Server/Proxy.
A5. In order to retrieve device-related network information, the traffic steering and shaping decision function sends a request for device-related network information to a device context acquisition function that is also implemented at the MPTCP Server/Proxy.
A6. The device context acquisition function then contacts one or both of the first RAN and the second RAN (i.e. that carry the subflows of the MPTCP connection) to obtain device-related network information (e.g. load, bit rates etc). Of course, the device context acquisition function could also retrieve device-related network information from other sources such as the nodes of a core network and/or the nodes of a service network; however, this is not illustrated in FIG. 10.
A7. The device context acquisition function then sends a response to the traffic steering and shaping decision function including the obtained device-related network information.
A8. The traffic steering and shaping decision function uses the device-related network information received from the device context acquisition function to decide whether any traffic steering and shaping actions should be implemented for the initial subflow and/or the further subflow of the MPTCP connection.
A9. The traffic steering and shaping decision function then sends a control message to a traffic steering and shaping execution function that is also implemented at the MPTCP Server/Proxy, wherein the control message includes the traffic steering and shaping decision.
A10. The traffic steering and shaping execution function implements the received traffic steering and shaping decision by performing appropriate actions in relation to the initial subflow and/or the further subflow of the MPTCP connection. For example, if the decision from the traffic steering and shaping decision function indicates that the initial subflow carried over the first RAN should be throttled, the traffic steering and shaping execution function implemented at the MPTCP Server/Proxy can simply map fewer packets onto the initial subflow, and steer traffic towards the further subflow carried over the second RAN.

In the example described in relation to FIG. 10, the MPTCP Server/Proxy makes use of a device context acquisition function to obtain network information that is relevant to the device. However, if the functions that are required to enable the traffic steering and shaping are implemented at an MPTCP Proxy, then this node can be located in one of the RANs that carry the subflows of the MPTCP connection or in the core network. In this case, the MPTCP Proxy may have access to network information, and will therefore not be required to use a device context acquisition function to obtain network information that is relevant to the device. Although, even if the MPTCP Proxy does have access to some network information, it may still make use of a device context acquisition function to obtain further network information that is relevant to the device. For example, if the MPTCP Proxy implementing the relevant functions is located in a node of the RAN that carries the initial subflow of the MPTCP connection, then the MPTCP Proxy can make use of a device context acquisition function to obtain network information from any other RAN that is carrying a further subflow of the MPTCP connection and/or from a core network, and/or a service network.

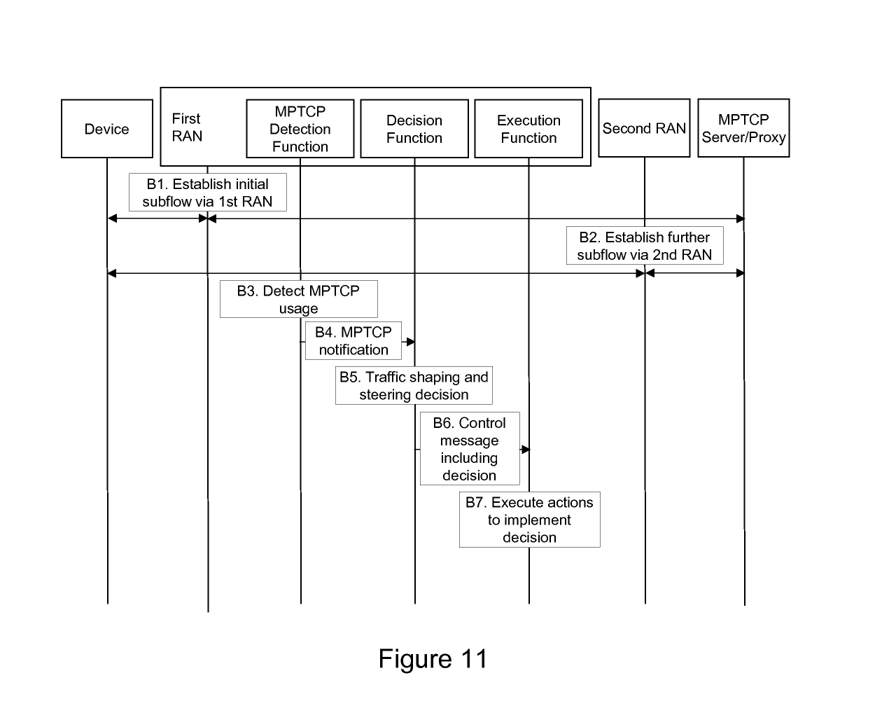

FIG. 11 is a signalling flow diagram illustrating an example of an implementation of the method described herein. In this example, an intermediate node located within a first RAN implements all of the functions that are required to enable the traffic steering and shaping of the subflows of the MPTCP connection. The steps performed are as follows:

B1. The device establishes an initial TCP connection with the MPTCP Server/Proxy through a first RAN that, in this example, is an E-UTRAN. During establishment of this initial TCP connection, both the device and the MPTCP Server/Proxy include optional headers that indicate that they support MPTCP.
B2. The device then establishes a further TCP connection with the MPTCP Server/Proxy through a second RAN that, in this example, is a WLAN. During establishment of this further TCP connection, the device includes an optional header indicating that this further TCP connection is to be joined with the initial TCP connection as a MPTCP connection. The initial TCP connection and the further TCP connection are therefore subflows of the MPTCP connection.
B3. In this example, the functions that are required to enable the traffic steering and shaping are implemented at an eNodeB of the E-UTRAN (i.e. the first RAN). Therefore, an MPTCP detection function implemented at the eNodeB detects that MPTCP is being used for the communication between the device and the MPTCP Server/Proxy by performing packet inspection of the packets/TCP segments of the initial subflow. In addition, in this example, the packet inspection also allows the MPTCP detection function to determine the traffic division between all of the subflows of the MPTCP connection, based on the Data Sequence Signal option.
B4. The MPTCP detection function therefore notifies a traffic steering and shaping decision function, which is also implemented at the eNodeB, and includes traffic division information in the notification sent to the traffic steering and shaping decision function.
B5. As the traffic steering and shaping decision function is located in the eNodeB, it is already aware of the network information of the E-UTRAN that is relevant to the device. The traffic steering and shaping decision function therefore uses this device-related network information received to decide whether any traffic steering and shaping actions should be implemented for the initial subflow and/or the further subflow of the MPTCP connection.
B6. The traffic steering and shaping decision function then sends a control message to a traffic steering and shaping execution function that is also implemented at the eNodeB, wherein the control message includes the traffic steering and shaping decision.
B7. The traffic steering and shaping execution function then determines appropriate actions that it can perform in relation to the initial subflow of the MPTCP connection in order to implement the decision, and executes the determined actions. For example, if the decision from the traffic steering and shaping decision function indicates that the initial subflow carried over the E-UTRAN should be throttled, the traffic steering and shaping execution function can lower the scheduling priority of packets/TCP segments of the initial subflow, or can stop forwarding packets/TCP segment of the initial subflow. In doing so, the eNodeB actively induces packet losses and/or delay for the initial subflow, such that the in-built TCP congestion control mechanisms will reduce the data rate of the initial subflow. This indirectly results in steering traffic towards the further subflow carried over the WLAN.

In the example described in relation to FIG. 11, the functions that are required to enable the traffic steering and shaping are implemented at an eNodeB of the E-UTRAN. However, these functions could equally be implemented in any intermediate node within any RAN that carries a subflow of the MPTCP connection (e.g. base stations, access points, routers, controllers, packet gateways).

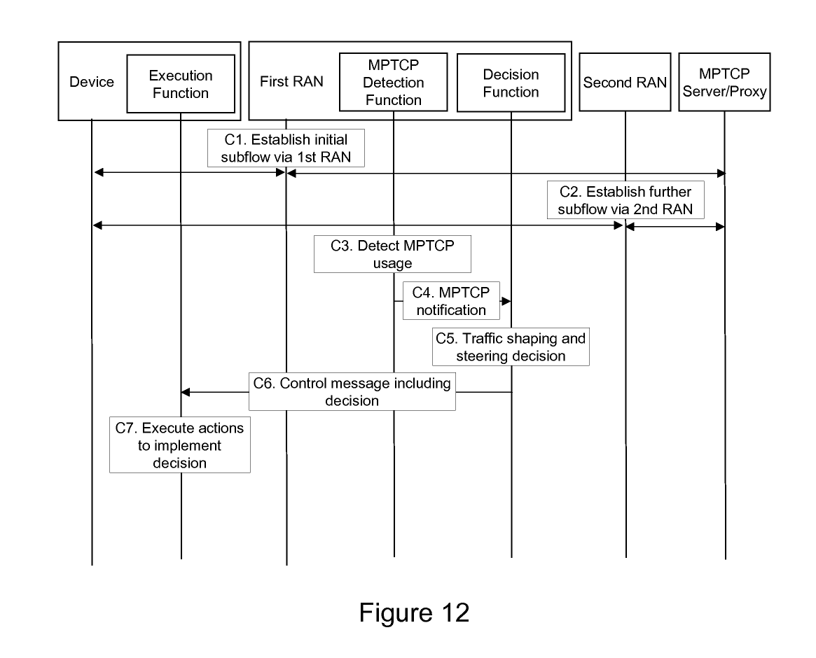

FIG. 12 is a signalling flow diagram illustrating an example of an implementation of the method described herein. In this example, an intermediate node located within a first RAN implements the MPTCP detection function and the traffic steering and shaping decision function, whilst the device implements the traffic steering and shaping execution function. The steps performed are as follows:

C1. The device establishes an initial TCP connection with a MPTCP Server/Proxy through a first RAN that, in this example, is an E-UTRAN. During establishment of this initial TCP connection, both the device and the MPTCP Server/Proxy include optional headers that indicate that they support MPTCP.
C2. The device then establishes a further TCP connection with the MPTCP Server/Proxy through a second RAN that, in this example, is a WLAN. During establishment of this further TCP connection, the device includes an optional header indicating that this further TCP connection is to be joined with the initial TCP connection as a MPTCP connection. The initial TCP connection and the further TCP connection are therefore subflows of the MPTCP connection.
C3. In this example, the MPTCP detection function and the traffic steering and shaping decision function are implemented at an eNodeB of the E-UTRAN (i.e. the first RAN). Therefore, the MPTCP detection function implemented at the eNodeB detects that MPTCP is being used for the communication between the device the MPTCP Server/Proxy by performing packet inspection of the packets/TCP segments of the initial subflow.
C4. The MPTCP detection function therefore notifies a traffic steering and shaping decision function that is also implemented at the eNodeB.
C5. As the traffic steering and shaping decision function is located in the eNodeB it is already aware of the network information of the E-UTRAN that is relevant to the device. The traffic steering and shaping decision function therefore uses this device-related network information received to decide whether any traffic steering and shaping actions should be implemented for the initial subflow and/or the further subflow of the MPTCP connection.
C6. The traffic steering and shaping decision function then sends a control message to the traffic steering and shaping execution function that is implemented at the device, wherein the control message includes the traffic steering and shaping decision.
C7. The traffic steering and shaping execution function implements the received traffic steering and shaping decision by performing appropriate actions in relation to the initial subflow and/or the further subflow of the MPTCP connection. For example, if the decision from the traffic steering and shaping decision function indicates that the initial subflow carried over the E-UTRAN should be throttled, the traffic steering and shaping execution function implemented at the device can simply map fewer packets onto the initial subflow, and steer traffic towards the further subflow carried over the WLAN.

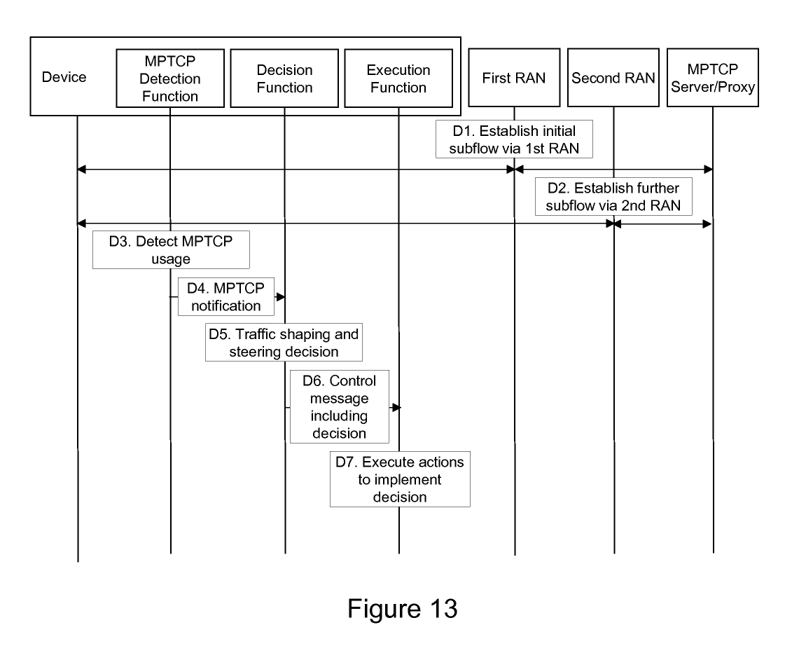

FIG. 13 is a signalling flow diagram illustrating an example of an implementation of the method described herein. In this example, the device implements all of the functions that are required to enable the traffic steering and shaping of the subflows of the MPTCP connection. The steps performed are as follows:

D1. The device establishes an initial TCP connection with a MPTCP Server/Proxy through a first RAN that, in this example, is an E-UTRAN. During establishment of this initial TCP connection, both the device and the MPTCP Server/Proxy include optional headers that indicate that they support MPTCP.
D2. The device then establishes a further TCP connection with the MPTCP Server/Proxy through a second RAN that, in this example, is a WLAN. During establishment of this further TCP connection, the device includes an optional header indicating that this further TCP connection is to be joined with the initial TCP connection as a MPTCP connection. The initial TCP connection and the further TCP connection are therefore subflows of the MPTCP connection.
D3. The MPTCP detection function implemented at the device thereby detects that MPTCP is being used for the communication between the device and the MPTCP Server/Proxy.
D4. The MPTCP detection function therefore notifies a traffic steering and shaping decision function that is also implemented at the device.
D5. As the traffic steering and shaping decision function is located in the device it is already aware of some network information that is relevant to the device. For example, the device will be aware of it's own mobility state, the current bit-rates available to it in the RANs that are carrying the subflows, and the current radio conditions of the device. The traffic steering and shaping decision function therefore uses this device-related network information to decide whether any traffic steering and shaping actions should be implemented for the initial subflow and/or the further subflow of the MPTCP connection.
D6. The traffic steering and shaping decision function then sends a control message to the traffic steering and shaping execution function that is also implemented at the device, wherein the control message includes the traffic steering and shaping decision.
D7. The traffic steering and shaping execution function implements the received traffic steering and shaping decision by performing appropriate actions in relation to the initial subflow and/or the further subflow of the MPTCP connection. For example, if the decision from the traffic steering and shaping decision function indicates that the initial subflow carried over the E-UTRAN should be throttled, the traffic steering and shaping execution function implemented at the device can simply map fewer packets onto the initial subflow, and steer traffic towards the further subflow carried over the WLAN.

The methods and apparatus described above provide that the data traffic carried by a MPTCP connection can be shaped and/or steered between the subflows of the MPTCP connection. In doing so, the methods and apparatus described above overcome the problems that arise from the ‘greedy’ nature of a TCP connection. In particular, the methods and apparatus described above can be used to optimize the distribution of traffic between the subflows of an MPTCP connection based on any number of device-relevant factors, such as the conditions in the RANs carrying each of the subflows.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. For example, in the illustrated example signalling flow diagrams described above, only those messages and headers that are of particular relevance are shown. Those skilled in the art will be aware those messages and headers that have not been included in this illustration. In addition, whilst the above described embodiments provide specific examples of which nodes can implement each of the described functions, different grouping/distribution of the functions is possible. For example, in some cases it may be beneficial to combine or co-locate the MPTCP detection function and device context acquisition function. It is also possible to have multiple instances of each of the different functions. For example, there could exist multiple instances of the device context acquisition function, wherein each instances retrieves information from different sources.

### GLOSSARY

Regular/Single-Path TCP:

The standard version of TCP operating between a single pair of IP addresses and TCP ports.

Multipath TCP:

A modified version of the TCP protocol that supports the simultaneous use of multiple paths between hosts.

Path:

A sequence of links between a sender and a receiver, defined in this context by a source and destination address pair.

Host:

An end host either initiating or terminating a Multipath TCP connection.

Subflow:

A flow of TCP segments operating over an individual path, which forms part of a larger Multipath TCP connection. A subflow is started and terminated similarly to a regular TCP connection.

MPTCP Connection:

A set of one or more subflows over which an application can communicate between two end hosts.

1-25. (canceled)

26. A method of enabling traffic steering and shaping for subflows of a Multipath Transmission Control Protocol (MPTCP) connection of a device, wherein the subflows of the MPTCP connection are carried over a plurality of Radio Access Networks (RANs), the method comprising, at a traffic steering and shaping decision function:
determining that the device is communicating with an end host using MPTCP;
obtaining information that is relevant to the device for one or more of any of the plurality of RANs that carry a subflow of the MPTCP connection, a core network, and a service network; and
using the device-relevant information to decide whether any traffic steering and shaping should be applied to any of the subflows of the MPTCP connection.

27. The method of claim 26, wherein determining that the device is communicating with an end host using MPTCP comprises receiving a notification from an MPTCP detection function, the notification indicating that at an MPTCP connection is being used by the device.

28. The method of claim 27, wherein obtaining information that is relevant to the device comprises one or more of:
retrieving device-relevant information from the notification received from the MPTCP detection function;
retrieving device-relevant information that has previously been stored by the traffic steering and shaping decision function; and
sending a request for device-relevant information to, and receiving a response from, at least one device context acquisition function.

29. The method of claim 26, further comprising sending a control message to a traffic steering and shaping execution function, the control message instructing the traffic steering and shaping execution function to implement the traffic steering and shaping decision by executing any appropriate actions in relation to one or more of the subflows of the MPTCP connection.

30. A method of enabling traffic steering and shaping for subflows of a Multipath Transmission Control Protocol (MPTCP) connection of a device, wherein the subflows of the MPTCP connection are carried over a plurality of Radio Access Networks (RANs), the method comprising, at a MPTCP detection function:
detecting that the device is communicating with an end host using MPTCP; and
sending a notification to a traffic steering and shaping decision function, the notification indicating that an MPTCP connection is being used by the device, thereby allowing the traffic steering and shaping decision function to decide whether any traffic steering and shaping should be applied to any of the subflows of the MPTCP connection.

31. The method of claim 30, wherein detecting that the device is communicating with an end host using MPTCP comprises:
during setup of a subflow of the MTCP connection between the device and the end host, determining that both the device and the end host are MPTCP capable and that the device has indicated that MPTCP should be used.

32. The method of claim 30, wherein detecting that the device is communicating with an end host using MPTCP comprises performing packet inspection of packets sent over a subflow of the MTCP connection between the device and the end host.

33. The method of claim 30, further comprising using data sequence information in the subflow to determine traffic division between the subflow and a further subflow of the MPTCP connection, and including traffic division information in the notification sent to the traffic steering and shaping decision function.

34. A method of enabling traffic steering and shaping for subflows of a Multipath Transmission Control Protocol (MPTCP) connection of a device, wherein the subflows of the MPTCP connection are carried over a plurality of Radio Access Networks (RANs), the method comprising, at a device context acquisition function:
receiving a request for device-relevant information, the request including an identifier of the device;
using the identifier of the device to obtain information that is relevant to the device from one or more of any of the plurality of RANs that carry a subflow of the MPTCP connection, a core network, and a service network; and
sending a response including the obtained device related information.

35. The method of claim 34, wherein the request is received from, and the response is sent to, a traffic steering and shaping decision function.

36. A method of enabling traffic steering and shaping for subflows of a Multipath Transmission Control Protocol (MPTCP) connection of a device, wherein the subflows of the MPTCP connection are carried over a plurality of Radio Access Networks (RANs), the method comprising, at a traffic steering and shaping execution function:
receiving a control message instructing the traffic steering and shaping execution function to implement a traffic steering and shaping decision;
determining actions that can be performed in order to implement the decision; and
implementing the traffic steering and shaping decision by executing the determined actions in relation to one or more of the subflows of the MPTCP connection.

37. The method of claim 36, wherein the control message is received from a traffic steering and shaping decision function.

38. The method of claim 36 wherein the actions for implementing the traffic steering and shaping decision comprise any of:
dropping, re-directing or delaying any of packets, re-transmissions, or acknowledgements that are sent over one or more subflows of the MPTCP connection; and
implementing Explicit Congestion Notification (ECN) for one or more subflows of the MPTCP connection.

39. An apparatus configured to operate as a traffic steering and shaping decision function for enabling traffic steering and shaping for subflows of a Multipath Transmission Control Protocol (MPTCP) connection of a device, wherein the subflows of the MPTCP connection are carried over a plurality of Radio Access Networks (RANs), the apparatus comprising processing circuitry that includes a processor and memory, wherein the processing circuitry is configured to:
determine that the device is communicating with an end host using MPTCP;
obtain information that is relevant to the device for one or more of any of the plurality of RANs that carry a subflow of the MPTCP connection, a core network, and a service network; and
use the device-relevant information to decide whether any traffic steering and shaping should be applied to any of the subflows of the MPTCP connection.

40. The apparatus of claim 39, wherein the processing circuitry is further configured to receive a notification from an MPTCP detection function, the notification indicating that at an MPTCP connection is being used by the device.

41. The apparatus of claim 39, wherein the processing circuitry is further configured to obtain information that is relevant to the device by implementing one or more of:
retrieving device-relevant information from the notification received from the MPTCP detection function;
retrieving device-relevant information that has previously been stored by the traffic steering and shaping decision function; and
sending a request for device-relevant information to, and receiving a response from, at least one device context acquisition function.

42. The apparatus of claim 39, wherein the processing circuitry is further configured to generate and send a control message to a traffic steering and shaping execution function, the control message instructing the traffic steering and shaping execution function to implement the traffic steering and shaping decision by executing any appropriate actions in relation to one or more of the subflows of the MPTCP connection.

43. An apparatus configured to operate as a Multipath Transmission Control Protocol (MPTCP) detection function for enabling traffic steering and shaping for subflows of a MPTCP connection of a device, wherein the subflows of the MPTCP connection are carried over a plurality of Radio Access Networks (RAN) the apparatus comprising processing circuitry that includes a processor and memory, wherein the processing circuitry is configured to:
detect that the device is communicating with an end host using MPTCP; and
generate and send a notification to a traffic steering and shaping decision function, the notification indicating that a MPTCP connection has been established for the device, thereby allowing the traffic steering and shaping decision function to decide whether any traffic steering and shaping should be applied to any of the subflows of the MPTCP connection.

44. The apparatus of claim 43, wherein the processing circuitry is further configured to, during setup of a subflow of the MTCP connection between the device and the end host, determine that both the device and the end host are MPTCP capable and that the device has indicated that MPTCP should be used.

45. The apparatus of claim 43, wherein the processing circuitry is further configured to perform packet inspection of packets sent over one or more subflows of the MTCP connection between the device and the end host.

46. The apparatus of claim 43, wherein the processing circuitry is further configured to use data sequence information carried in the subflows of the MTCP connection to determine traffic division between the subflows, and to include traffic division information in the notification sent to the traffic steering and shaping decision function.

47. An apparatus configured to operate as a device context acquisition function for enabling traffic steering and shaping for subflows of a Multipath Transmission Control Protocol (MPTCP) connection of a device, wherein the subflows of the MPTCP connection are carried over a plurality of Radio Access Networks (RAN) the apparatus comprising processing circuitry that includes a processor and memory, wherein the processing circuitry is configured to:
receive a request for device-relevant information, the request including an identifier of the device;
use the identifier of the device to obtain information that is relevant to the device from one or more of any of the plurality of RANs that carry a subflow of the MPTCP connection, a core network, and a service network; and
generate and send a response including the obtained device related information.

48. An apparatus configured to operate as a traffic steering and shaping execution function for enabling traffic steering and shaping for subflows of a Multipath Transmission Control Protocol (MPTCP) connection of a device, wherein the subflows of the MPTCP connection are carried over a plurality of Radio Access Networks (RAN) the apparatus comprising processing circuitry that includes a processor and memory, wherein the processing circuitry is configured to:
receive a control message instructing the traffic steering and shaping execution function to implement a traffic steering and shaping decision, and to determine actions that can be performed in order to implement the decision; and
implement the traffic steering and shaping decision by executing the determined actions in relation to one or more of the subflows of the MPTCP connection.

49. The apparatus of claim 48, wherein the processing circuitry is configured to execute actions that comprise any of:
dropping, re-directing or delaying any of packets, re-transmissions, or acknowledgements that are sent over one or more subflows of the MPTCP connection; and
implementing Explicit Congestion Notification (ECN) for one or more subflows of the MPTCP connection.

50. The apparatus of any of claim 48, wherein the apparatus is a node within a path over which any of the subflows of the MPTCP connection operates.
